(19) United States
(12) Patent Application Publication
(10) Pub. No.: US 2007/0226451 A1
(43) Pub. Date: Sep. 27, 2007

(54) Method and apparatus for full volume mass storage device virtualization

(76) Inventors: Antonio S. Cheng, Portland, OR (US); Kirk D. Brannock, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/387,204

(22) Filed: Mar. 22, 2006

(51) Int. Cl. G06F 12/00

(52) U.S. Cl. 711/203; 711/170

(57) ABSTRACT

A storage command specifying a virtual linear block address (“LBA”) is converted to a device command specifying a physical LBA and issued to a mass storage device. Chipsets to translate between virtual LBAs and physical LBAs, systems using such chipsets, and machine-readable media containing software to control programmable logic devices, are among the embodiments described and claimed.

### FIELD

The invention relates to mass storage management. More specifically, the invention relates to virtualization of mass storage devices.

### BACKGROUND

Applications for computers and similar data processing systems often require non-volatile storage to hold information that does not fit in the system's volatile working memory, or to preserve information across restart and power cycles. Non-volatile storage is frequently provided by a mass storage device such as a hard disk or solid state, battery-backed or Flash memory.

Early disk drives required the controlling system to identify data for reading or writing by its physical location on the disk, using cylinder, head, and sector (“CHS”) coordinates. However, as drive capacity increased, it became apparent that a logical data addressing scheme would simplify system programming and permit mass storage systems to implement useful features such as automatic damaged-sector remapping.

According to a commonly-used logical addressing scheme, a mass storage device such as a hard disk may be treated as a sequentially-numbered array of data blocks, each to hold a group of data bytes. (Blocks of 512 bytes each are common.) Thus, for example, data on a one gigabyte (“GB”) hard disk may be stored or retrieved by providing a linear block address (“LBA”) from zero (for the first 512 bytes) to 2²¹−1(2,097,151, for the last 512 bytes). (Note that some hard disk manufacturers prefer the International System of Units (“SI”) definition of 10⁹ bytes for “gigabyte,” so a disk providing 2³⁰ bytes of storage might be considered a 1.074 GB device.) Controlling logic in the hard disk can convert the LBA to a physical location on the disk's recordable media and read or write data as directed by the system. The disk may have additional capacity (in excess of 1 GB) that the controller uses to store information of its own, or to replace sectors that are damaged or worn out.

Starting with the LBA model of a mass storage device as a sequence of blocks numbered from zero to a highest-numbered block, computers and data processing systems often sub-divide the available storage into contiguous sections called partitions. Within a partition, raw block-by-block storage is often managed by a data structure called a filesystem that permits arbitrarily-sized segments of information to be stored and retrieved, associated with a name, and organized in a hierarchical fashion. However, some specialized applications may use an entire partition, or even an entire mass storage device, without a filesystem or other intermediate organizing structure.

For applications that require contiguous storage exceeding that available in a single partition or a single mass storage device, systems to aggregate multiple storage devices and provide a unified view of the group have been developed. For example, a Redundant Array of Independent Disks (“RAID array”) can be configured to provide access to storage on several devices, where data blocks are identified by a single LBA between zero and the total capacity of the array.

Recently, though, systems and usage models that need less storage have been developed. Unfortunately, these models have other requirements so that simply using less than all of a disk, or dividing the disk into smaller partitions, produces unacceptable results. Alternative methods for managing mass storage device capacity may be useful for some applications.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an overview of an embodiment of the invention.

FIG. 2 shows details of a system that can implement an embodiment.

FIG. 3 is a flow chart of operations of an embodiment.

FIGS. 4A and 4B show applications that can benefit from an embodiment.

FIG. 5 is a block diagram of a mobile system that can benefit from an embodiment of the invention.

### DETAILED DESCRIPTION

Embodiments of the invention present an interface to portions of the storage available on a mass storage device, where each portion is smaller than the total storage available. The interface permits blocks within each portion to be addressed by a linear block address (“LBA”) from zero to a highest-numbered block within the portion, and translates the LBA to a second LBA according to the location of the portion's storage on the underlying mass storage device. For clarity, an LBA used to identify a block within one of the portions is called a “virtual LBA” or “vLBA,” while an LBA used to identify a block on the underlying mass storage device is called a “physical LBA” or “pLBA.”

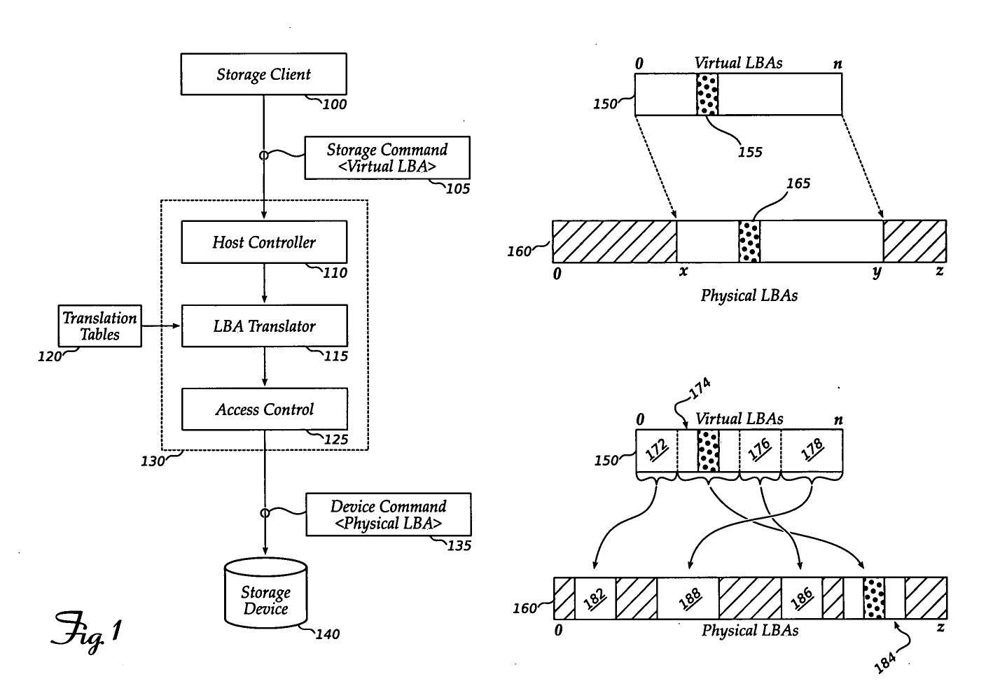

FIG. 1 shows an overview of an embodiment of the invention. Storage client 100, which may be a software task or hardware device, issues a storage command 105 containing a virtual LBA. (The client may not be aware that the LBA is virtual—it may only know the number of blocks in the portion of the storage device, and select an LBA accordingly.) The command may be to read or write data on storage device 140, or to perform some other operation on storage device 140 for which a linear block address is required.

Storage command 105 is received by host controller 110, whose function it is to convert the storage command into a device command 135 suitable to cause storage device 140 to perform the requested function. Before device command 135 reaches storage device 140, an LBA translator 115 will convert the vLBA from client 100 into a corresponding physical LBA so that the proper data block of storage device 140 is read, written, or otherwise affected. LBA translator 115 refers to information in translation tables 120 to perform the vLBA-to-pLBA translation. Access control logic 125 may also participate in the processing of device command 135 by checking to be sure storage client 100 has appropriate permissions to perform the requested function.

In some embodiments, host controller 110, LBA translator 115 and access control logic 125 may be closely integrated, as suggested by dashed line 130. In other embodiments, LBA translator 115 may intercept and alter device command 135 as it passes from host controller 110 to storage device 140.

Storage device 140 receives device command 135 containing the translated physical LBA and executes the command, perhaps by writing data or by reading and returning data at the specified physical LBA. (Some commands return, rather than receive, LBAs. For example, a command to obtain a description of the disk might return the number of blocks in the device—the highest valid LBA. For those commands, the LBA translation may occur as the information returns from storage device 140 to host controller 110 and eventually to storage client 100.)

Element 150 shows the view storage client 100 has of the storage device: virtual LBAs o through n identify blocks of storage available to client 100. In this example, the virtual LBA provided with storage command 105 may identify a data block 155.

Element 160 shows the actual data storage available on storage device 140: physical LBAs 0 through z identify blocks of storage. However, because of the virtual LBA to physical LBA translation performed by LBA translator 115, data blocks identified by physical LBAs 0 through x are inaccessible to storage client 100. Also, data blocks identified by physical LBAs y through z are inaccessible. These inaccessible blocks are indicated by cross-hatching. The data block identified by the virtual LBA in storage command 105 may actually reside within the physical LBA sequence at location 165.

Elements 150 and 160 show a straightforward linear mapping of virtual LBAs to a contiguous set of physical LBAs. However, in some embodiments, LBA translator 115 may perform a more complicated mapping. Element 170 shows how virtual LBAs 0 through n may be divided into segments 172, 174, 176 and 178, and each segment placed at non-contiguous locations within the physical storage 180 available on storage device 140. Segments 172, 174, 176 and 178 need not be the same size, and the physical LBAs 182, 184, 186 and 188 corresponding to those segments need not be in the same order. Note that this sort of physical-to-virtual mapping bears some resemblance to the mapping of pages of virtual memory to “page frames” in a physical memory, as performed in many modern computer operating systems. Algorithms and techniques of use in that field may be applied to manage the allocation of virtual LBAs to physical LBAs in embodiments of the present invention.

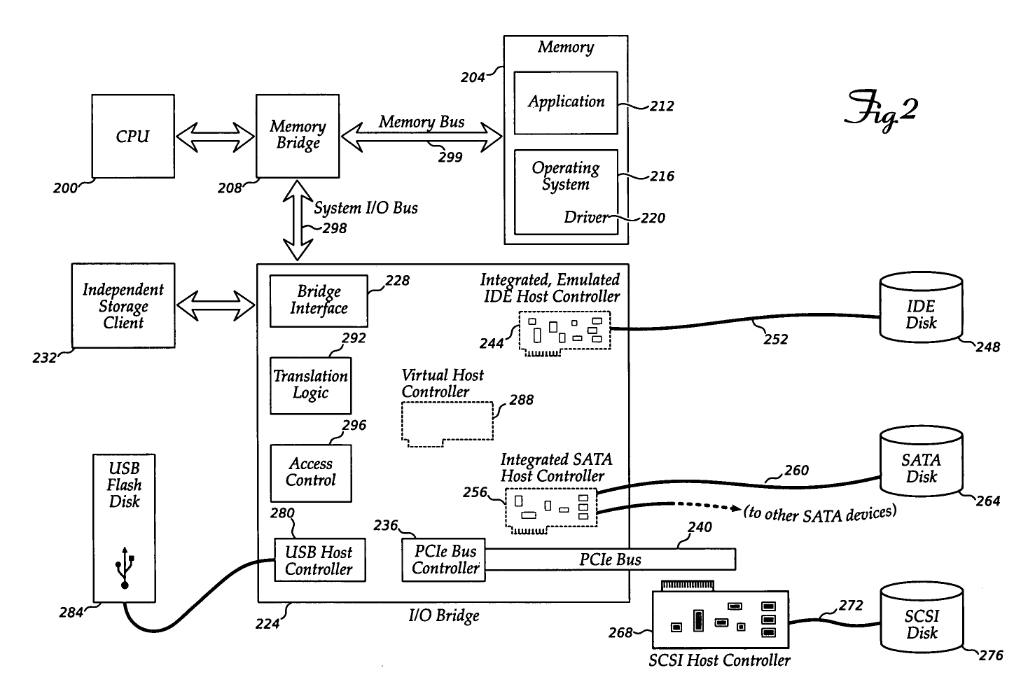

FIG. 2 shows a number of components of a computer system that implements an embodiment of the invention. A system may have a central processing unit (“CPU” or “processor”) 200 to execute instructions contained in a memory 204. Memory bridge 208 may coordinate data traffic between CPU 200 and memory 204, and may permit other devices to read or write data in memory as well. Memory 204 may contain instructions and data for an application 212 or an operating system 216. Instructions and data to control the operation of a hardware device are commonly called a “device driver,” or simply a “driver” 220.

A system may have another component to coordinate data traffic between various hardware devices, CPU 200 and memory 204. This component is shown here as input/output (“I/O”) bridge 224. I/O bridge 224 includes bridge interface logic 228 to receive I/O requests from storage clients such as driver 220 and independent storage client 232 and to return data and/or status information to those clients. I/O bridge 224 may include several bus controllers: protocol logic and signaling circuitry to interact with hardware devices connected via various device I/O buses. Bus controllers send commands and data to, and receive replies from the hardware devices. These hardware devices, often called “host controllers,” communicate with mass storage devices over peripheral buses that carry commands and data.

The example system shown here includes a bus controller 236 for a Peripheral Component Interconnect (“PCI”) Express (“PCI-Express” or “PCIe”) bus 240. (PCI Express® and PCIe™ are registered trademarks of PCI Special Interest Group of Portland, Oreg.) Other systems may include controllers for PCI-X or Accelerated Graphics Port (“AGP”) buses.

Various host controllers are also shown: element 244 is an Integrated Device Electronics (“IDE”) host controller to communicate with IDE disk 248 over IDE peripheral bus 252; Serial Advanced Technology Attachment (“SATA”) host controller 256 interfaces with SATA peripheral bus 260 to communicate with SATA disk 264; Small Computer Systems Interface (“SCSI”) host controller 268 interfaces with SCSI peripheral bus 272 to communicate with SCSI disk 276; and Universal Serial Bus (“USB”) host controller 280 permits communication with USB flash disk 284. Host controllers may be add-in interface cards (e.g. SCSI host controller 268) or may be integrated into the I/O bridge or other chipset (e.g. SATA host controller 256 and USB host controller 280). Some host controllers may emulate other host controllers to support obsolescent peripheral devices (e.g. IDE emulator 244). An I/O bridge according to an embodiment of the invention may contain a virtual host controller 288 that can interact with a storage client such as driver 220 or independent storage client 232 as if it was a real host controller, but may then forward commands on to another (real) host controller for execution on a mass storage device.

The functionality of an embodiment of the invention resides logically at a host controller or between a controller and its storage device. Its exact location is a matter of design choice. For example, making LBA translation logic 292 and access control 296 generally available to host controllers integrated in or connected to I/O bridge 224, as shown in FIG. 2, may permit the virtualization of more types of storage devices. Placing translation logic 292 and access control 296 in a single host controller may be easier or more cost-effective, but may limit virtualization functionality to devices connected to that host controller.

Translation logic 292 receives requests from a host controller that is processing a storage client's command and translates virtual LBAs to physical LBAS. Translation logic 292 may include state memory (not shown) to store mapping information to perform the translations. Translation tables 130 mentioned in the description of FIG. 1 are an example of such state memory.

Note that storage client commands specify virtual LBAs, which may be translated into physical LBAs by translation logic 292. Other LBA manipulations or conversions might occur under the control of application 212 or operating system 216, but an LBA transmitted over system I/O bus 298 to I/O bridge 224 identifies a data block within a virtual storage device (i.e. a portion of a physical storage device), not a data block on the physical storage device itself.

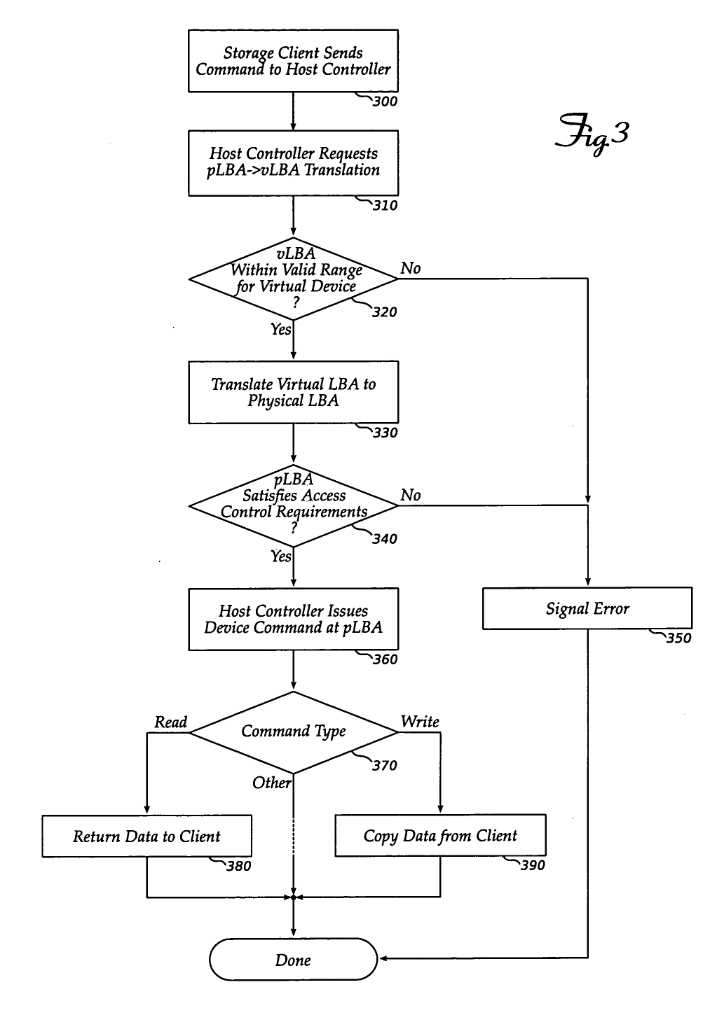

FIG. 3 is a flow chart of operations of an embodiment of the invention. First, a storage client transmits a storage command to a host controller (300). The command specifies a linear block address, which will be treated as a virtual LBA by an embodiment of the invention. The host controller requests a translation from virtual LBA to physical LBA (310). The vLBA may be examined to ensure that it is within a valid range of LBAs for the virtual device (320)—if the vLBA is invalid, an error may be signaled (350).

Next, the vLBA is translated it to a physical LBA (330). A simple translation may be adding a block address offset to the vLBA to obtain the pLBA. More complex translations may, for example, distribute sub-ranges of the virtual storage device at various locations on the physical storage device. Access control logic may check the pLBA to ensure that the requested access is to be permitted (340); if the access check fails, an error may be signaled (350). Embodiments may perform range checks on the pLBA and access checks on the vLBA (the reverse of the procedure just explained), or perform both sorts of checks on either the vLBA or pLBA.

Now, a host controller issues a device command corresponding to the storage command from the storage client (360). The device command specifies the physical LBA obtained by translating the virtual LBA. The device command is sent (and responses, if any, are received) over a peripheral bus such as an IDE bus, a SCSI bus, a SATA bus, or a Universal Serial Bus. Communications between the system and the host controller may occur over a device I/O bus such as an ISA bus, PCI bus, PCI-X bus, PCI-Express bus, or AGP bus. In the case of an integrated host controller, the device I/O bus may use a proprietary protocol. If the command type is “read,” data from the physical device may be returned to the storage client (380). If the command type is “write,” data from the storage client may be copied to the physical device (390). Other command types may call for different post-command-issuance processing (not shown).

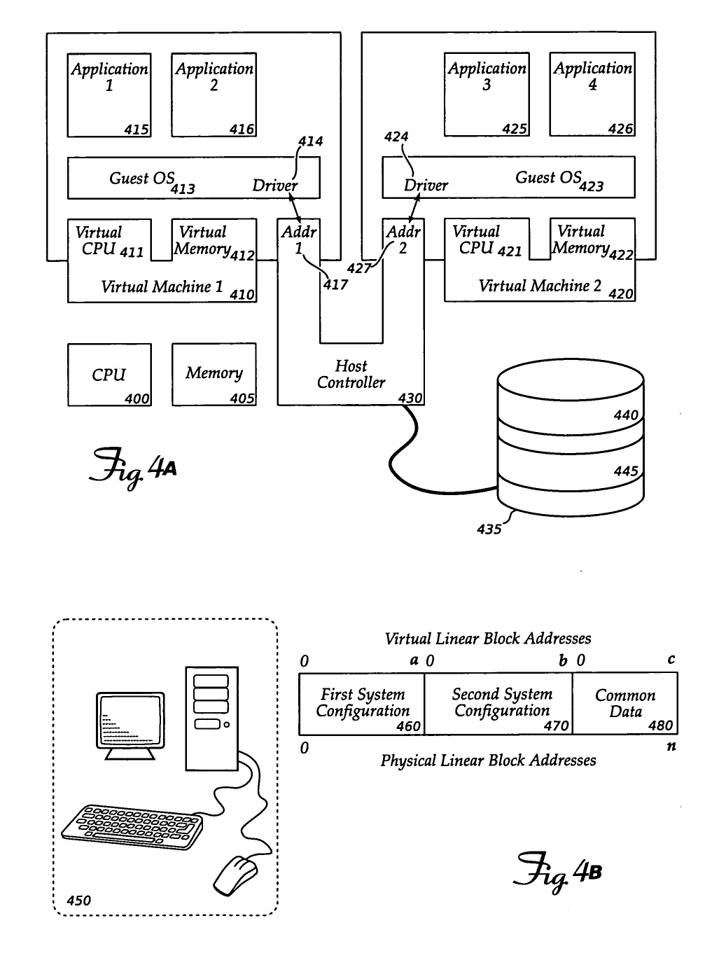

FIGS. 4A and 4B show two applications where an embodiment of the invention may provide useful capabilities. FIG. 4A shows a CPU 400, memory 405, and host controller 430 connected to a physical mass storage device 435. These hardware elements support two virtual machines, 410 and 420. Software known as a Virtual Machine Monitor, or “VMM,” running on CPU 400 uses features of the CPU to create the impression of one or more independent virtual machines, so that software running on the virtual machine can operate as if it had independent and exclusive control of the virtual machine. For example, virtual machine 1 410 provides virtual CPU 411 and guest virtual memory 412 for use by guest OS 413 and applications 415 and 416. Driver 414 within guest OS 413 interacts with a virtualized interface of host controller 430 to store data on mass storage device 435.

Similarly, virtual machine 2 420 provides virtual CPU 421 and guest virtual memory 422 for use by guest OS 423 and applications 425 and 426. Driver 424 interacts with another virtualized interface of host controller 430 to store data on mass storage device 435.

Note that “virtual memory” as used here has a slightly different meaning from that commonly ascribed to the term. Here, it means memory available for use by guest applications running in the virtual machine.

In FIG. 4A, drivers 414 and 424 communicate with different virtualized interfaces of host controller 430 through command and data registers mapped into the address spaces of their respective virtual machines. This is a “memory mapped interface.” However, host controller 430 is mapped at a first address (“Addr 1,” 417) in virtual machine 1 410, and at a second address (“Addr 2,” 427) in virtual machine 2 420. Translation logic (not shown in this figure) can distinguish between requests from the different virtual machines based on these addresses, and can select a different vLBA-to-pLBA translation for each virtual machine. Thus, requests from storage clients from virtual machine 1 410 can be restricted to portion 440 of storage device 435, while requests from storage clients from virtual machine 2 420 can be restricted to portion 445. Neither virtual machine can access the portion of storage device 435 devoted to the other virtual machine, nor can either access other portions outside its assigned area.

A similar, alternate implementation is also possible. Instead of providing two virtualized interfaces to the same host controller, an embodiment may use two host controllers that share access to the same downstream physical ports. Each virtual machine would use one of the two host controllers, and different vLBA-to-pLBA translations would be performed according to the host controller requesting the translation. Other methods of distinguishing requests from different virtual machines can also be used when appropriate hardware or software (VMM) support is available. It is not necessary for the distinguishing features to be visible to guest software in a virtual machine.

Note that the VMM or other virtual machine control software may be free to emulate any sort of hardware or system feature it wishes to provide to guest systems. Therefore, a VMM might be designed to provide functionality similar to that of embodiments of the invention by intercepting guest operations intended to affect a virtual storage device and adjusting LBAs appropriately. However, this software solution may be significantly slower than the host-controller-coupled LBA translation described herein, and furthermore may be vulnerable to inadvertent or malicious software anomalies that could undermine the separation of virtual storage volumes.

FIG. 4B shows an alternate usage model. There, a computer system 450 may have a mass storage device divided into several portions containing virtual storage volumes 460, 470 and 480. When system 440 is initialized, one of first system configuration 460 and second system configuration 470 is selected, and the corresponding virtual linear block addresses (0 through a or 0 through b) are made available by appropriate configurations in the system's translation tables. Common data 480 may be available as a second virtual volume regardless of the system configuration selected. Again, portions of the physical volume outside the sub-portions accessible through the vLBA-to-pLBA translation are inaccessible to storage clients on the system. The system shown in FIG. 4B can be operated with the selected system configuration without risk of the other configuration becoming corrupted by malfunctioning or malicious software. Initialization and alteration of the vLBA-to-pLBA translation tables may be protected by access control or encryption to prevent inadvertent or intentional re-configuration that might permit access to portions of the physical volume that were intended to be inaccessible.

An embodiment of the invention may store information necessary to perform vLBA-to-pLBA translations in a non-volatile memory of the system, or may record this data on the mass storage device (perhaps in an area inaccessible to storage clients under normal circumstances). Access control information may be stored in the same location. Placing translation and access control information on the storage device itself may permit the device to be successfully transferred to a different system, preserving the various virtual storage devices contained thereon.

Microelectronic circuitry to perform the various translation, bus protocol and signaling functions mentioned above may be integrated into a single monolithic package or distributed among several physical devices. In either form, the circuitry may be called a “chipset.” Chipsets may contain hardwired logic, (re)programmable logic, microcode instructions and a processor to execute them, or a combination of these and other elements, to cause the chipset to operate as described above.

An embodiment of the invention may be used in connection with a mobile device such as a laptop computer, a cell phone, a personal digital assistant, or other similar device with on-board processing capability and a wireless communication interface that is powered by a direct current (DC) power source that supplies DC power to the mobile device and that is solely within the mobile device and needs to be recharged on a periodic basis, such as a fuel cell or a battery.

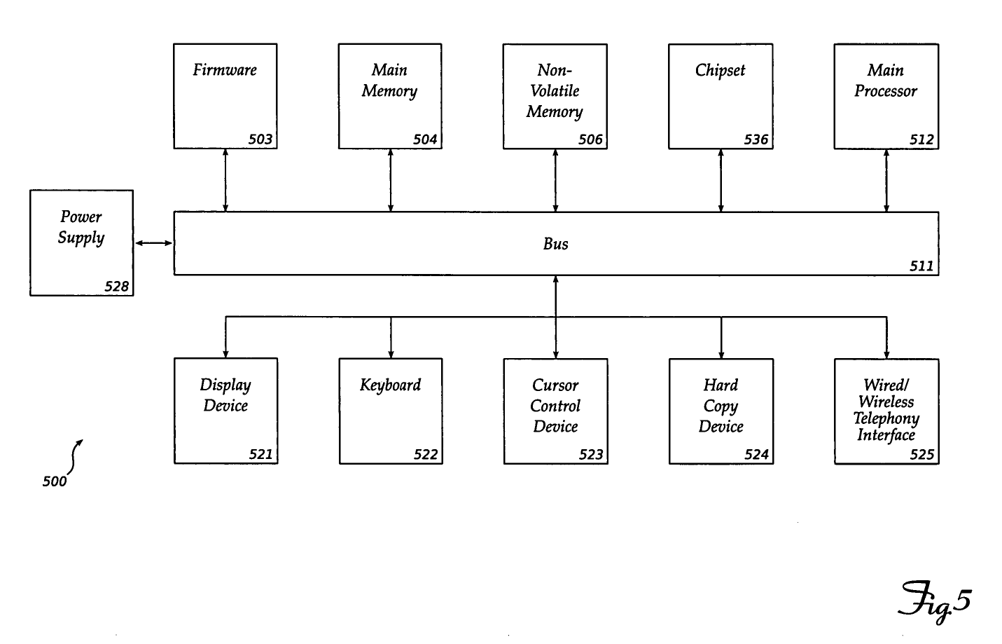

FIG. 5 is a block diagram of an example computer system that may use an embodiment of the invention. In one embodiment, computer system 500 comprises a communication mechanism or bus 511 for communicating information, and an integrated circuit component such as a main processing unit 512 coupled with bus 511 for processing information. One or more of the components or devices in the computer system 500 such as the main processing unit 512 or a chip set 536 may implement an embodiment of the platform management logic described above. The main processing unit 512 may include one or more processor cores working together as a unit.

Computer system 500 further comprises a random access memory (“RAM”) or other dynamic storage device 504 (referred to as main memory) coupled to bus 511 for storing information and instructions to be executed by main processing unit 512. Main memory 504 also may be used for storing temporary variables or other intermediate information during execution of instructions by main processing unit 512.

Firmware 503 may be a combination of software and hardware, such as Electronically Programmable Read-Only Memory (EPROM) that has the operations for the routine recorded on the EPROM. The firmware 503 may embed foundation code, basic input/output system code (BIOS), or other similar code. The firmware 503 may make it possible for the computer system 500 to boot itself.

Computer system 500 also comprises a read-only memory (ROM) and/or other static storage device 506 coupled to bus 511 for storing static information and instructions for main processing unit 512. The static storage device 506 may store OS level and application level software.

Computer system 500 may further be coupled to or have an integral display device 521, such as a cathode ray tube (“CRT”) or liquid crystal display (“LCD”), coupled to bus 511 for displaying information to a computer user. A chipset may interface with the display device 521.

An alphanumeric input device (keyboard) 522, including alphanumeric and other keys, may also be coupled to bus 511 for communicating information and command selections to main processing unit 512. An additional user input device is cursor control device 523, such as a mouse, trackball, trackpad, stylus, or cursor direction keys, coupled to bus 511 for communicating direction information and command selections to main processing unit 512, and for controlling cursor movement on a display device 521. A chipset may interface with the input output devices.

Another device that may be coupled to bus 511 is a power supply 528 such as a battery and alternating current (“AC”) adapter circuit. Furthermore, a sound recording and playback device, such as a speaker and/or microphone (not shown) may optionally be coupled to bus 511 for audio interfacing with computer system 500. Another device that may be coupled to bus 511 is a wireless communication module 525. The wireless communication module 525 may employ a Wireless Application Protocol (“WAP”) to establish a wireless communication channel. The wireless communication module 525 may implement a wireless networking standard such as the IEEE 802.11 standard (IEEE standard 802.11-1999, published by IEEE in 1999.)

In one embodiment, the software used to facilitate the routine can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory including firmware; random access memory; magnetic disk storage media; optical storage media; flash memory devices; etc.)

The applications of the present invention have been described largely by reference to specific examples and in terms of particular allocations of functionality to certain hardware and/or software components. However, those of skill in the art will recognize that mass storage devices can be virtualized by software and hardware that distribute the functions of embodiments of this invention differently than herein described. Such variations and implementations are understood to be captured according to the following claims.

We claim:

1. A method comprising:
receiving a storage command from a client, the storage command to include a first linear block address (“LBA”);
translating the first LBA to a second LBA; and
interacting with a mass storage device to operate on a storage location identified by the second LBA.

2. The method of claim 1 wherein receiving comprises obtaining the storage command at a host controller.

3. The method of claim 1 wherein interacting comprises communicating with the device over a peripheral bus.

4. The method of claim 3 wherein the peripheral bus is one of an Integrated Device Electronics (“IDE”) bus, a Small Computer Systems Interface (“SCSI”) bus, a Serial Advanced Technology Attachment (“SATA”) bus, or a Universal Serial Bus.

5. The method of claim 1, further comprising:
verifying that the first LBA falls within a range of valid LBAs for a virtual storage device.

6. The method of claim 1, further comprising:
configuring a translation table to contain information for translating the first LBA to the second LBA.

7. The method of claim 1 wherein translating comprises adding a block address offset to the first LBA to obtain the second LBA.

8. The method of claim 1 wherein the storage command is a read command or a write command.

9. The method of claim 1 wherein the first LBA is a number between zero and a number of data blocks of a virtual mass storage device.

10. The method of claim 1, further comprising:
validating at least one of the first LBA and the second LBA to determine whether the client is permitted to execute the storage command.

11. A chipset comprising:
a host controller to accept a command from a storage client and to return data to the storage client; and
translation logic to convert a first linear block address (“LBA”) from the command or the data to a second LBA.

12. The chipset of claim 11, further comprising:
state memory to store mapping information for performing the conversion; and
configuration logic to initialize the state memory.

13. The chipset of claim 11, further comprising:
a bus controller to communicate with the host controller over a device input/output bus,
wherein the bus controller is one of a Peripheral Component Interconnect (“PCI”) bus controller, a PCI-X bus controller or a PCI-Express bus controller.

14. The chipset of claim 11 wherein the host controller is one of an Integrated Device Electronics (“IDE”) host controller, a Small Computer Systems Interface (“SCSI”) host controller, or a Serial Advanced Technology Attachment (“SATA”) host controller.

15. The chipset of claim 11 wherein the host controller has a memory-mapped interface.

16. The chipset of claim 15 wherein the memory-mapped host controller responds to commands at a plurality of memory ranges, each of the memory ranges to correspond to an independent LBA conversion.

17. A system comprising:
a processor;
translation logic;
a host controller; and
a mass storage device; wherein
the processor is to issue a storage command to the host controller, the command to include a first linear block address (“LBA”);
the translation logic is to translate the first LBA to a second LBA; and
the host controller is to read or write data on the mass storage device at a location identified by the second LBA.

18. The system of claim 17, further comprising:
a system input/output (“I/O”) bus to carry commands and data between the processor and the host controller; and
a peripheral bus to carry commands and data between the host controller and the mass storage device.

19. The system of claim 18 wherein the peripheral bus is one of an Integrated Device Electronics (“IDE”) bus, a Small Computer Systems Interface (“SCSI”) bus, a Universal Serial Bus (“USB”) or a Serial Advanced Technology Attachment (“SATA”) bus.

20. The system of claim 17, further comprising a bus controller to perform signaling and protocol transactions according to an interface protocol.

21. The system of claim 20 wherein the interface protocol is one of a Peripheral Component Interconnect (“PCI”) interface, a PCI-X interface, or a PCI-Express interface.

22. A machine-readable medium containing instructions to cause a programmable logic device to perform operations comprising:
receiving a command from a client, the command to obtain a description of a mass storage device;
interacting with the mass storage device to retrieve the description;
translating a first linear block address (“LBA”) in the description to a second LBA; and
returning a translated description with the second LBA to the client.

23. The machine-readable medium of claim 22, containing further instructions to cause the programmable logic device to perform operations comprising:
configuring a translation table to contain information for translating the first LBA to the second LBA.

24. The machine-readable medium of claim 22 wherein the programmable logic device is to communicate with the mass storage device over a peripheral bus.

25. The machine-readable medium of claim 24 wherein the peripheral bus is one of an Integrated Device Electronics (“IDE”) bus, a Small Computer Systems Interface (“SCSI”) bus, a Serial Advanced Technology Attachment (“SATA”) bus, or a Universal Serial Bus (“USB”).
